(19) United States
(12) Patent Application Publication
(10) Pub. No.: US 2004/0235603 A1
(43) Pub. Date: Nov. 25, 2004

(54) Continuously variable transmission

(76) Inventor: Anthony L. Peck, Eastbourne (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/803,727

(22) Filed: Mar. 18, 2004

(30) Foreign Application Priority Data
Mar. 20, 2003 (GB) 0306441.7

(51) Int. Cl. F16H 47/04

(52) U.S. Cl. 475/169

(57) ABSTRACT

A continuously variable transmission has an orbital gear with an eccentric pin. The orbital gear rotates about an internal gear and has a radius one-third of the radius of the internal gear. Arcuate members are provided for transmitting linear motion of a drive rod to an output rod. A continuously variable transmission is provided with an output shaft speed being substantially constant at a given constant input shaft speed.

### CROSS-REFERENCE TO RELATED APPLICATION

This application claims priority to Great Britain Patent Application No. 0306441.7 filed on Mar. 20, 2003, entitled CONTINUOUSLY VARIABLE TRANSMISSION.

### BACKGROUND OF THE INVENTION

The present invention relates to continuously variable transmissions, such as for continuously or infinitely varying ratios between input and output shafts thereof.

U.S. patent application Publication No. US2002/0100340 discloses a continuously variable transmission having an output shaft and an input shaft and a slide for continuously varying a ratio between input and output shaft speeds. However, it is not possible to obtain a 1:0 input to output shaft speed ratio, meaning that the transmission is not suitable for some applications, such as for transmitting torque for starting the movement of agricultural or railway vehicles and the like from rest when an extremely low gear ratio is desirable. Additionally, although three phases are provided in the transmission, each phase is substantially sinusoidal, such that at a constant input shaft speed, the output shaft speed is lumpy, consisting of the highest points of three sign waves which are 120° out of phase with one another. Furthermore, the step of changing the gear ratio directly and actively causes a displacement of the output shaft relative to the input shaft. In other words, with the input shaft held stationary, adjusting the gear ratio would result in a rotation of the output shaft and it can clearly be seen therefore that very substantial force would be needed simply to adjust the gear ratio such that, for example, when the transmission is used in the vehicle disclosed in U.S. patent application Publication No. US2002/0100340, the force required for changing the gear ratio would be so great that simply changing the gear ratio would need to and would result in rotation of the output shaft pushing the vehicle along.

In U.S. Pat. No. 5,392,664, an anti-ripple link is employed in an attempt to avoid a lumpy output for the output shaft. However, it is considered that the anti-ripple linkages shown would not provide ripple-free output speed at all gear ratios and the arrangements shown incorporate substantial undesirable frictional sliding between an outer eccentric and a surrounding annular ring in the drive train between the input shaft and output shaft.

Furthermore, changing the gear ratio by rotation of outer and inner eccentrics of the transmission relative to one another is considered likely to undesirably and actively result in the transmission of relative movement between the input and output shafts such that, as in U.S. patent application Publication No. US2002/0100340, substantial force is needed to change gear.

The present invention aims to alleviate the problems of the prior art.

### SUMMARY OF THE INVENTION

According to a first aspect of the present invention, there is provided a continuously variable transmission comprising a rotary input shaft, a rotary output shaft, and a drive train unit between the input and output shafts, the drive train unit including adjuster means for continuously varying the ratio of input shaft speed to output shaft speed, and regulator means for regulating output shaft speed to be substantially constant at a given substantially constant input shaft speed, characterized in that the regulator means includes an orbital wheel being adapted to transmit power from an output element located eccentrically thereon.

The use of the orbital wheel with an eccentrically located output element, such as an output drive pin, is highly advantageous in that it enables a substantially constant and substantially ripple-free linear speed of motion to be provided in the drive train. This linear speed may be converted back into a constant rotational speed at the output shaft and the adjuster may preferably be incorporated to continuously vary the constant linear speed of an element, such as a linearly slidable drive rod in the drive train in order to provide a continuously variable ratio between input and output speeds, without the output characteristics being lumpy.

Preferably, at a truly constant input shaft speed, the output shaft has a minimum rotational speed which is more than 50% of the maximum output shaft speed. In one embodiment, the minimum output shaft speed is at least 90% of the maximum output shaft speed. However, in a preferred embodiment, the minimum output shaft speed is more than 99% of the maximum output shaft speed. In one embodiment, the minimum output shaft speed is 99.8% or more of the maximum output shaft speed at truly constant input shaft speed. These percentages also apply to the constancy of motion of the drive rod for a sufficient portion of its cycle such that several similar out of phase drive rods have respective overlapping cycle portions.

Preferably, the orbital wheel is driven in an orbit around an interior periphery of an internal wheel. The orbital wheel may be driven by an idler wheel. The orbital wheel and idler wheel may be connected together by a bearing plate which is rotatable on a main shaft, with centers of the idler gear and orbital wheel being pivotally connected to the bearing plate. The periphery of the orbital wheel may engage and be driven by the idler wheel. The idler wheel may engage and be driven by the internal periphery of the internal wheel.

Preferably, the orbital wheel has one-third of the radius of the internal wheel. This enables the regulator means to convert the essentially sinusoidal motion of the orbital wheel around the internal wheel into a linearly moving component of the velocity of the eccentrically located output element which is substantially constant.

Preferably, the eccentric output element is located between 0.05R to 0.25R, e.g. 0.1R to 0.15R from the center of the orbital wheel, where R is the distance of the center of the orbital wheel from the center of a circular orbiting motion thereof. In two examples, the eccentric output element is located 0.137R and 0.132R from the center of the orbital wheel, this value being 0.13268R in another example. In combination with the orbital wheel having one-third of the radius of the internal wheel, this positioning of the eccentric element enables a linear component of the velocity of the eccentric output element to be substantially constant in order to avoid ripple or lumpy output characteristics for the transmission.

Preferably each said wheel comprises a toothed gear. Accordingly, simple yet effective and strong drive may be provided to the output element.

Preferably, the output element is adapted to reciprocate a drive rod via a slot, the regulator means regulating the rod to move with a cycle having a portion of substantially constant speed linear motion. The rod is preferably linearly slidable.

Preferably, the slot is substantially perpendicular to the direction of reciprocation of the rod.

The regulator means may include a non-linear contour formed in the slot. This may assist in providing the rod with a substantially or absolutely constant speed linear motion at constant rotational input shaft speed for at least a portion of the cycle thereof.

According to a second aspect of the present invention, there is provided a continuously variable transmission comprising a rotary input shaft, a rotary output shaft, and a drive train unit between the input shaft and output shaft, the drive train unit including adjuster means for continuously varying the ratio of input shaft speed to output shaft speed, characterized in that the adjuster means is passively operable, whereby ratio change may be provided without actively driving the output shaft upon an input adjustment to the adjuster means. Accordingly, only a very small load is needed in order to change the gear ratio for transmission, and this is highly advantageous.

Preferably, the adjuster means includes a lost motion device enabling motion of an input adjuster of the adjuster means to be lost during a driving mode of the drive train unit. Preferably, a spring bias is provided for recovering the lost motion to change the transmission ratio during a non-driving mode of the drive train unit.

The adjuster means may include an arcuate member having one point thereon driven by the drive rod for selectively pivoting the arcuate member about a pivot point. Preferably, the arcuate member forms an arc whose center is at the center of the internal gear of the drive train and/or a center of a circular orbit of the orbital wheel.

Preferably, an output rod is provided with a point thereon adapted to be selectively driven by the arcuate member. The adjuster means preferably includes means for moving the pivot point for varying the ratio of input shaft speed to the output speed of the transmission. Accordingly, variation of gear ratio between input and output shafts may be accomplished easily.

The output rod may be adapted to drive the output shaft via a unidirectional coupling.

The transmission may include six said drive train units operating at 60° steps out of phase with one another. By virtue of the use of the unidirectional couplings, the fastest phase will always be the phase driving the output shaft and with each unit providing substantially ripple-free output shaft speed for 60° or more of each cycle, a substantially constant output shaft speed may be assured. In another embodiment, 12 said drive train units could be employed operating at 30° steps out of phase with one another. Alternatively, 18 said drive train units operating at 20° steps out of phase with one another could be employed and other arrangements are envisioned. More generally, three or more said drive train units may be employed operating at equal steps out of phase with one another, 4, 6, 8, 12 and 18 said units being just some examples.

Preferably, the adjuster is operable to a 1:0 input to output shaft speed ratio. This may be achieved by enabling the pivot point of the arcuate member to align with the drive point for the output rod, such that reciprocation of the linearly slidable rod simply causes reciprocation of the arcuate member without the transmission of any movement to the output rod. As an example only, the adjuster may be operable to provide a range of gear ratios of input to output shaft speed such as 1:0 to 1:1 or higher or lower at the top end as desired.

According to a further aspect of the present invention, there is provided a continuously variable transmission comprising a rotary input shaft, a rotary output shaft and a drive train unit between the input and output shafts, the drive train unit including adjuster means for continuously varying the ratio of input shaft speed to output shaft speed, and a regulator means for regulating output shaft speed to be substantially constant at a given substantially constant input shaft speed, characterized in that the regulator means includes an orbital wheel adapted to reciprocate a linearly slidable rod by a slot, the slot having a non-linear contour for regulating the rod to move with a cycle having a portion of substantially constant speed linear motion.

The present invention also extends to machinery and vehicles incorporating a continuously variable transmission as set out in the earlier aspects of the invention mentioned above.

### BRIEF DESCRIPTION OF THE DRAWINGS

The present invention may be carried out in various ways and one embodiment of a continuously variable transmission in accordance with the invention will now be described by way of example with reference to the accompanying drawings, in which:

FIG. 1 is a sectional end view of input parts of a continuously variable transmission in accordance with a preferred embodiment of the present invention, with a worm adjuster of the transmission not shown for the purposes of clarity.

FIG. 2 is a side view of the components as shown in FIG. 1.

FIG. 3 is an enlarged view of gears shown in FIGS. 1 and 2.

FIGS. 4A, 4B and 4C are respective side top and end views of various speed ratio varying components of the transmission of FIGS. 1 to 3.

FIGS. 5A and 5B show respective end and side views of various output components of the transmission of FIGS. 1 to 4C.

FIGS. 6A and 6B show respective side and sectional end views of a modified contoured slot and slide bearing block for the transmission, FIG. 6B being a section on A-A in FIG. 6A.

FIG. 7 shows schematically a vehicle incorporating the transmission of FIGS. 1 to 6B.

FIG. 8 shows a graph representative of drive rod speed in Table 1.

FIGS. 9A to 9C are views of a speed worm gear adjuster for the transmission.

FIG. 10 is a schematic view of a retardation device for the transmission.

FIG. 11 is an enlarged view of the graph of drive rod speed in FIG. 8.

### DETAILED DESCRIPTION OF THE PREFERRED EMBODIMENT

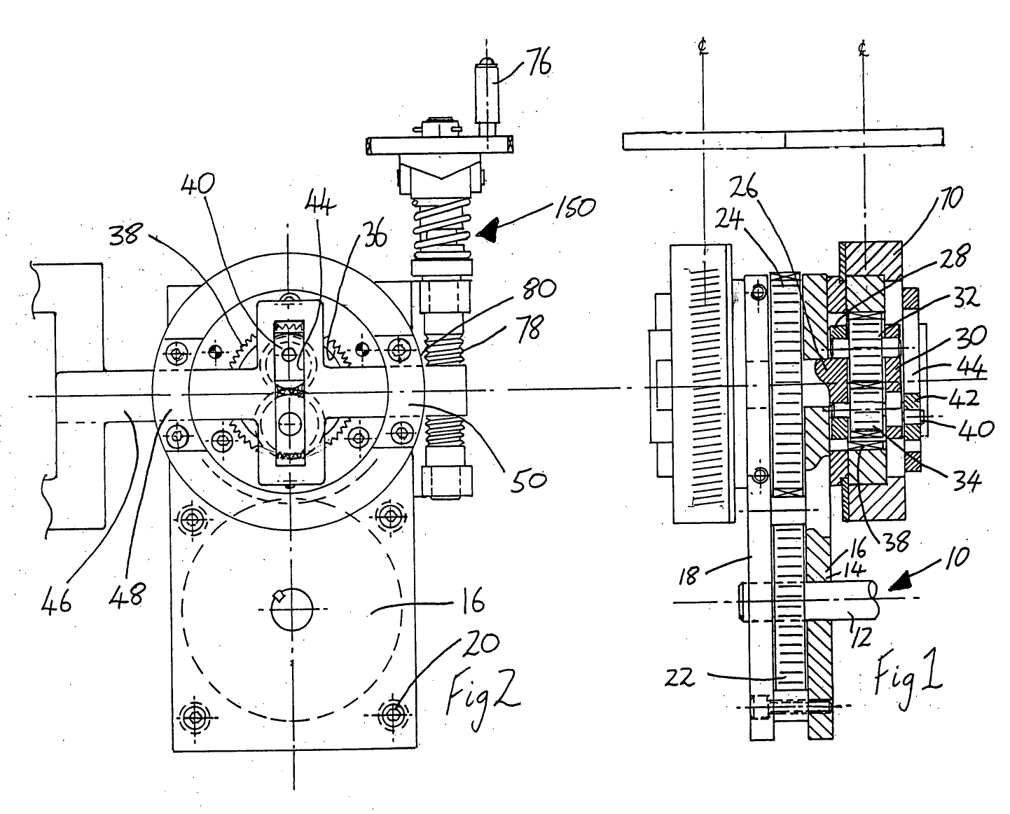

As shown in FIG. 1, a continuously variable transmission 10 in accordance with a preferred embodiment of the present invention has an input shaft 12 which is journalled in a frame assembly 14, the frame assembly 14 having two plates 16,18, held together by bolts 20.

Keyed on the input shaft 12 is an input shaft drive gear 22 which meshes with and drives a main shaft gear 24 which is also journalled in the frame assembly plates 16,18. The main shaft gear 24 is keyed on a main shaft 26. The main shaft includes a bearing plate 28 and second bearing plate 30, the bearing plates 28,30 holding an idler gear 32 and orbital gear 34. The idler gear 32 meshes with the internal periphery 36 of an internal gear 38. The idler gear 32 also meshes with the orbital gear 34. The orbital gear 34 has an eccentric pin 40 journalled in a slide bearing block 42 which engages in a slot 44 of a linearly reciprocating drive rod 46 which slides in linear bearings 48,50. The orbital gear 34 has a radius which is one-third of the radius of the internal gear and also has one-third of the number of teeth on the internal gear 38. The eccentricity of the pin 40 is 0.13268 times the distance from the center of the internal gear 38 to the center of the orbital gear 34.

Accordingly, rotation of the input shaft 12 causes the input shaft drive gear 22 to drive the main shaft gear 24. The rotation of the main shaft 26 causes the idler gear 32 to orbit around the inside of the internal gear 38 and the orbital gear 34 also has an orbital motion. The geometry is such that with a constant input shaft speed the eccentric pin 40 has a cycle including a portion having a linear component in the longitudinal direction of the drive rod 46 which is substantially constant for one-sixth of the cycle and in fact is so constant that the minimum speed of the drive rod 46 during this substantially constant period is 99.8% of the maximum speed of the drive rod therein.

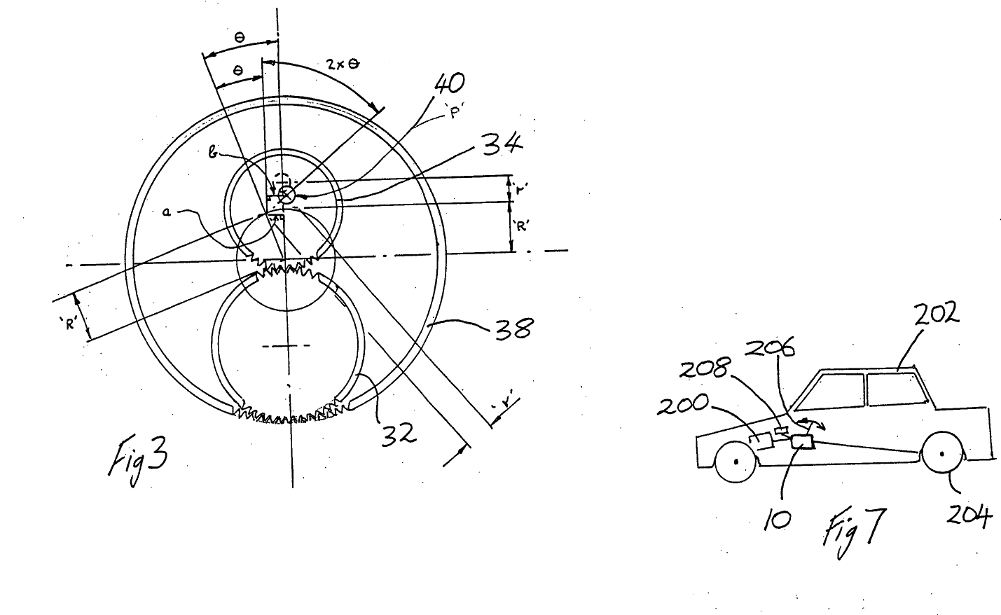

As shown in FIG. 3, in which r=0.13268R and the drawing is not to scale for illustrative purposes, the horizontal position of pin 40 at any given angle of rotation within the quadrant is given by a−b, where a=(sin φ)×R and b=(sin (2φ))×r.

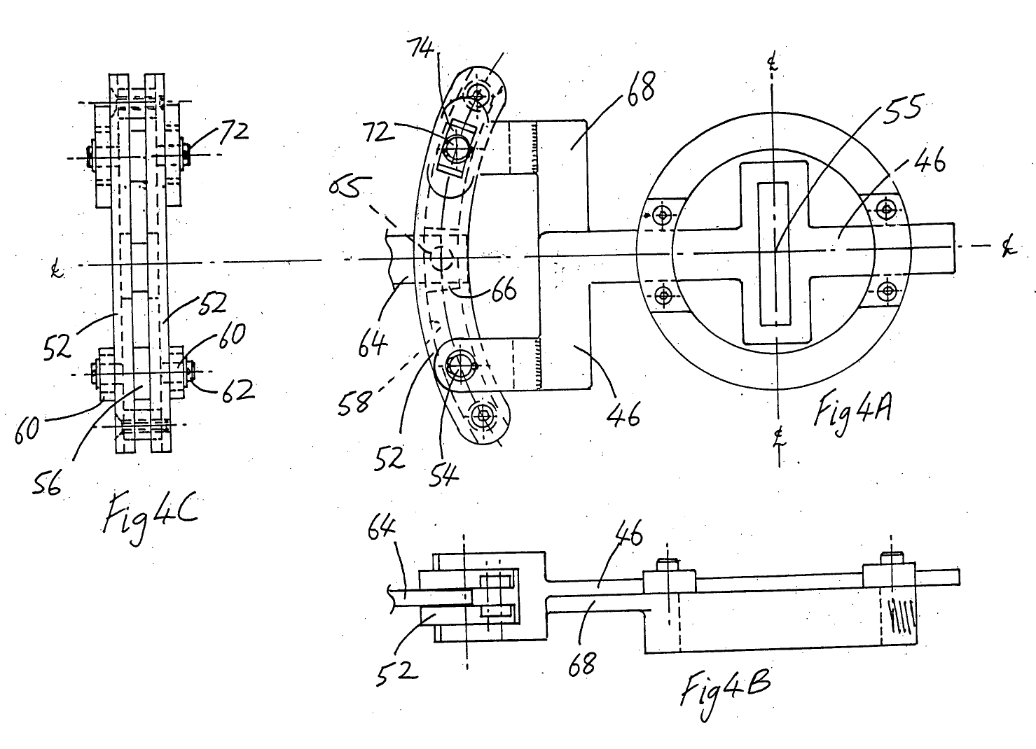

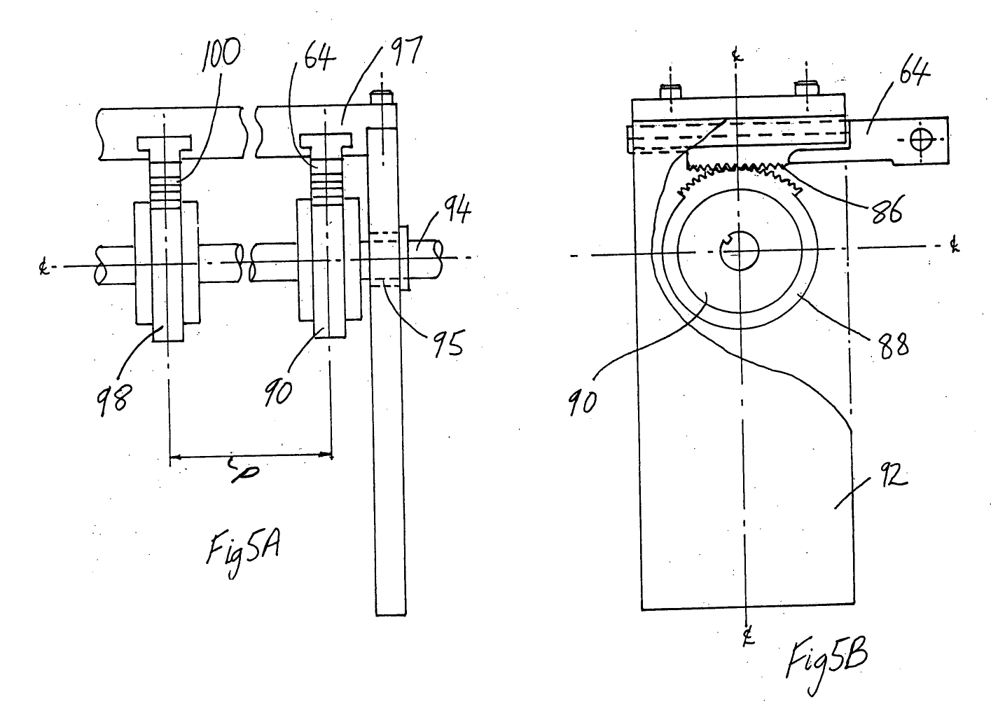

As shown in FIG. 4A, the linearly reciprocating drive rod 46 acts upon a pair of arcuate members 52, whose arc is an arc of a circle whose center 55 is in the same place as the center of the internal gear 38. The reciprocating drive rod 46 has a pin 54 located in a bearing secured in a track 58 formed between the arcuate members 52. The pin 54 is held in position by washers 60 and circlips 62 or the like. An output rod 64 is also shown in FIGS. 4A,4B and 4C, the output rod 64 having a pin 65 connected to a bearing slide block 66 located in the track 58. Additionally, a normally fixed arm 68 is provided, the fixed arm 68 having an annulus 70 at one end surrounding the internal gear 38 and having a pivot pin 72 and slider block 74 at the other end thereof. By turning a handle 76 which drives a worm gear 78 acting upon external gears 80 on the annulus 70, the fixed arm 68 and the reciprocating arm can move up and down. A maximum output shaft speed may be achieved by rotating the fixed arm 68 and reciprocating drive rod 46 upwards in FIG. 4A such that the pin 54 of the reciprocating drive rod 46 comes close to being into line with the output rod 64. Rotation of the fixed arm 68 and reciprocating drive rod 46 in the opposite direction will reduce the gear ratio until a zero ratio is achieved when the pin 72 of the fixed arm 68 is brought into line with the output rod 64. The slide block 74 for the fixed arm 68 allows movement of the pin 54 to be linear such as to take into account the slightly varying distance between the two pins 54,72 during the reciprocating action. Further downstream in the drive train, as shown in FIGS. 5A and 5B, the output rod 64 has a rack 86 driving a part-toothed collar 88 of a unidirectional device 90 mounted in a stationary frame 92, the unidirectional device driving an output shaft 94. Output shaft 94 is held in a plurality of bearings 95. The rack 86/output rod are supported by rack slide block 97.

It will be seen from FIG. 1 that the frame 14 of the unit in fact supports a second similar drive unit, the second drive unit also consisting of a similar idler gear, orbital gear, reciprocating drive rod, fixed arm, arcuate members, output rod, and unidirectional device, this second unidirectional device 98 being shown in FIG. 5A along with the associated linearly sliding rack 100, equivalent to the output rod 64. Thus, the arrangement shown in FIG. 1 is a double unit, including two phases of the overall device. As shown in FIG. 5A, the pitch “P” between unidirectional devices is arranged to match the appropriate double unit centers. The overall device includes three double units, therefore providing six phases with six drive train units, each providing a substantially constant speed output for the output shaft 94 for 60° of the 360° cycle. It will be appreciated that the single output shaft 94 is driven by the six unidirectional devices of the six phases.

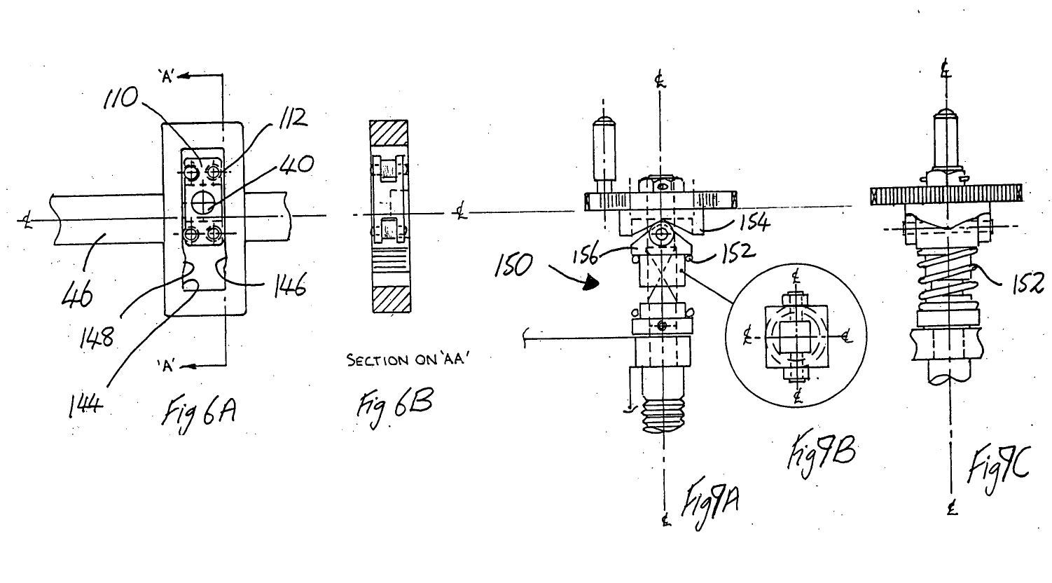

FIGS. 6A and 6B show a modification in which the eccentric pin 40 is journalled in a slide bearing block 110 fitted with rollers 112 to follow the contour of a contoured slot 144, the contoured slot including contour elements 146,148 further improving the constant speed of the output shaft to as near perfect as possible in practice subject to manufacturing tolerances.

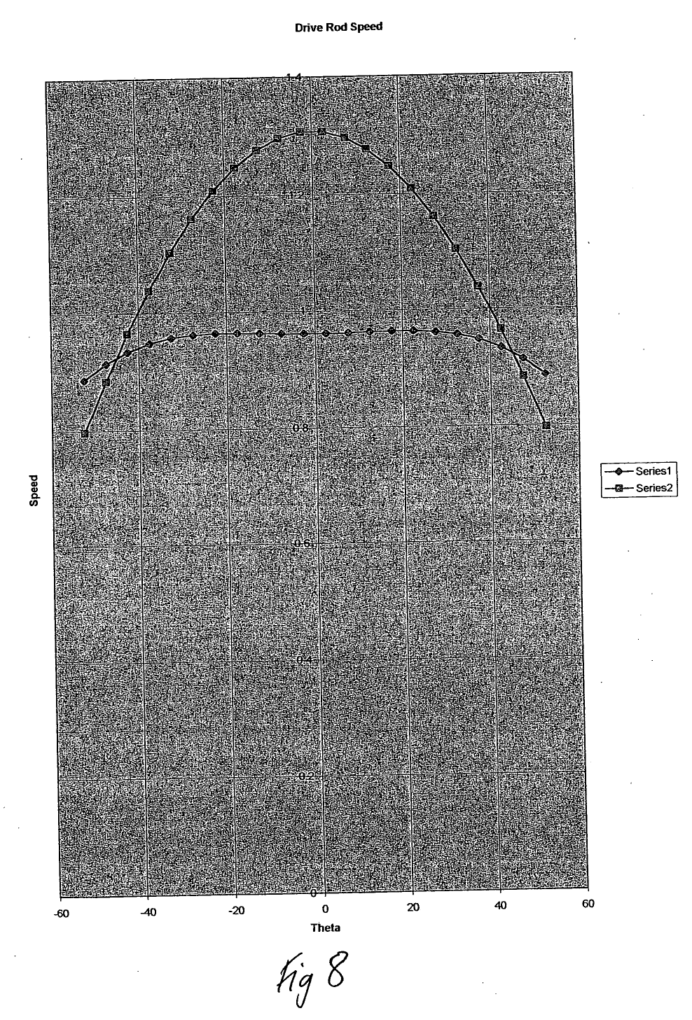

FIG. 8 includes two graphs in which Series 2 shows a sinusoidal speed as would be provided by one phase of a purely sinusoidal motion. Series 1 shows the linear speed provided at an output rod of one phase in the present embodiment and it will be seen that for at least 60° of a complete cycle actually between −50° and 50° as shown in FIG. 8, the speed is substantially constant. As shown more clearly in FIG. 11, the speed is constant to within about 0.4% between −30° and +30°. Due to the parallel linear motions of the drive rod 46 and output rod 64, the fixed position of the pivot pin 72 and the allowance provided by the block 66, a constant linear speed of the drive rod 46 is transmitted as a constant linear speed to the output rod 64.

Table 1 shows the speed of the eccentric pin 40 in the direction of the drive rod 46 and it will be seen that the difference in distance at 5° intervals as shown in FIG. 3 is substantially constant, the difference being shown in the last column on the right in table 1. FIG. 7 shows the transmission 10 driven by an engine 200 of a vehicle 202 having rear wheel drive through wheels 204, the transmission being variable by movement of a gear shift stick 206 in place of the handle 76. Alternatively, the transmission may be automatically variable by a computer 208, in order to maximize torque, acceleration, or maximum speed or efficiency of the vehicle, as desired. Adjustment of the input/output ratio of the device can be adjusted manually or the adjustment controlled by a computer if a suitably powered servo-motor is introduced to drive the adjustment mechanism. The vehicle may be a road vehicle or could be another type such as agricultural, railway or heavy haulage. The transmission is able to provide full torque/power at any vehicle velocity, and may be particularly useful for vehicles for pulling against heavy loads, such as locomotives or agricultural tractors, when pulling away from a stationary position. The device can also be used in reverse, i.e. to provide a constant output shaft speed from various input shaft speeds. Thus a controller may be provided for controlling the adjuster means to maintain output shaft speed constant upon variance of input shaft speed. Also, a constant output shaft speed could be achieved from continually varying input shaft speeds if required by using suitable servos and computer control. This feature would be extremely useful in the generation of AC electricity from wind, wave and tidal power sources where close control of the rotational speed of the generator is essential for matching frequencies. This may be useful in windmills, waterwheels and other arrangements. As shown in FIG. 8, which is a graph of the incremental differences in a−b and therefore is representative of drive rod speed for the arrangement with dimensions R=15 mm and r=1.9902 mm in table 1, between −30° and +30° speed varies between 0.960 and about 0.964 which is a speed variation of only about 0.4%. It will be appreciated that using 6 drive units, the particular drive rod graphed will only be in a drive mode from the −30° theta to the +30° theta point, taking over power from a second drive rod at the −30° point and handing over to another at the +30° point, the graphed drive rod being in a non-drive mode for the rest of its cycle. Eight said drive units, equally out of phase, may be provided in other embodiments.

| Radius R = 15 | | | Eccentric Offset r = 1.9902 | | | r/R = 0.13268 | | | |
|---|---|---|---|---|---|---|---|---|---|
| | | | | | | | | Incremental | Incremental |
| | | | | | | | Theta | Difference | diff |
| Angle Theta | | R * sin theta | Angle 2 * Theta | | r * sin (2 * theta) | | Midpoint | Between | Between |
| Radians | Degrees | a | Radians | Degrees | b | a − b | Degrees | Each a − b | R * sin Theta |
| −0.872664626 | −50 | −11.49066685 | −1.745329252 | −100 | −1.95996439 | −9.530702257 | | | |
| −0.785398163 | −45 | −10.60660172 | −1.570796327 | −90 | −1.9902 | −8.616401718 | −47.5 | 0.914300539 | 0.884064929 |
| −0.698131701 | −40 | −9.641814145 | −1.396263402 | −80 | −1.95996439 | −7.681849755 | −42.5 | 0.934551963 | 0.964787573 |
| −0.610865238 | −35 | −8.603646545 | −1.221730476 | −70 | −1.870176254 | −6.733470291 | −37.5 | 0.948379464 | 1.0381676 |
| −0.523598776 | −30 | −7.5 | −1.047197551 | −60 | −1.723563759 | −5.776436241 | −32.5 | 0.95703405 | 1.103646545 |
| −0.436332313 | −25 | −6.339273926 | −0.872664626 | −50 | −1.524581651 | −4.814692275 | −27.5 | 0.961743966 | 1.160726074 |
| −0.34906585 | −20 | −5.13030215 | −0.698131701 | −40 | −1.279275901 | −3.851026249 | −22.5 | 0.963666026 | 1.208971776 |
| −0.261799388 | −15 | −3.882285677 | −0.523598776 | −30 | −0.9951 | −2.887185677 | −17.5 | 0.963840573 | 1.248016473 |
| −0.174532925 | −10 | −2.604722665 | −0.34906585 | −20 | −0.680688489 | −1.924034176 | −12.5 | 0.963151501 | 1.277563012 |
| −0.087266463 | −5 | −1.307336141 | −0.174532925 | −10 | −0.345594603 | −0.961741538 | −7.5 | 0.962292638 | 1.297386524 |
| 0 | 0 | 0 | 0 | 0 | 0 | 0 | −2.5 | 0.961741538 | 1.307336141 |
| 0.087266463 | 5 | 1.307336141 | 0.174532925 | 10 | 0.345594603 | 0.961741538 | 2.5 | 0.961741538 | 1.307336141 |
| 0.174532925 | 10 | 2.604722665 | 0.34906585 | 20 | 0.680688489 | 1.924034176 | 7.5 | 0.962292638 | 1.297386524 |
| 0.261799388 | 15 | 3.882285677 | 0.523598776 | 30 | 0.9951 | 2.887185677 | 12.5 | 0.963151501 | 1.277563012 |
| 0.34906585 | 20 | 5.13030215 | 0.698131701 | 40 | 1.279275901 | 3.851026249 | 17.5 | 0.963840573 | 1.248016473 |
| 0.436332313 | 25 | 6.339273926 | 0.872664626 | 50 | 1.524581651 | 4.814692275 | 22.5 | 0.963666026 | 1.208971776 |
| 0.523598776 | 30 | 7.5 | 1.047197551 | 60 | 1.723563759 | 5.776436241 | 27.5 | 0.961743966 | 1.160726074 |
| 0.610865238 | 35 | 8.603646545 | 1.221730476 | 70 | 1.870176254 | 6.733470291 | 32.5 | 0.95703405 | 1.103646545 |
| 0.698131701 | 40 | 9.641814145 | 1.396263402 | 80 | 1.95996439 | 7.681849755 | 37.5 | 0.948379464 | 1.0381676 |
| 0.785398163 | 45 | 10.60660172 | 1.570796327 | 90 | 1.9902 | 8.616401718 | 42.5 | 0.934551963 | 0.964787573 |
| 0.872664626 | 50 | 11.49066665 | 1.745329252 | 100 | 1.95996439 | 9.530702257 | 47.5 | 0.914300539 | 0.884064929 |

In order to further assist in changing gear ratio without providing a change force which must be transferred to the output shaft (i.e. a force so substantial, as in the prior art, that the gear change control would power a rotation at the output shaft), the worm gear 78 is connected to the handle 76 via a rotational spring-bias system 150 with a lost motion function.

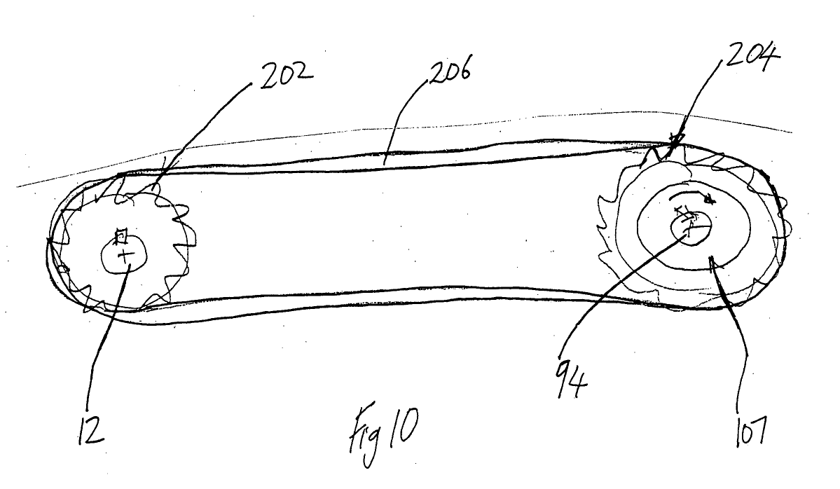

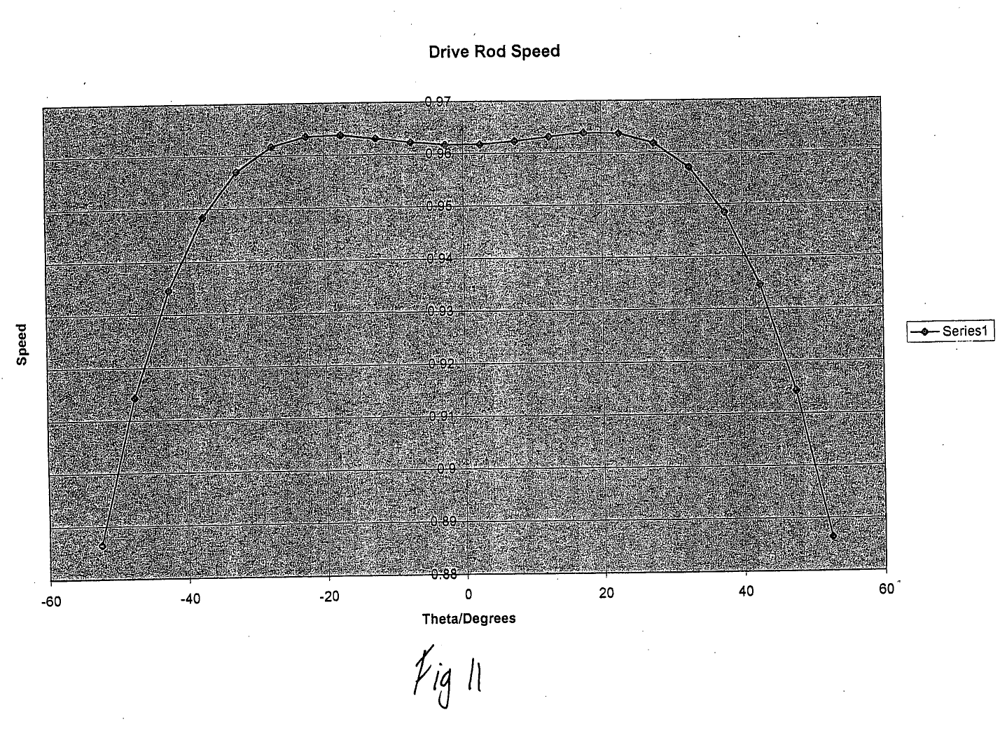

As shown in FIGS. 9A, 9B and 9C, rotational spring bias system 150 includes a spring 152 adapted to bias wedges 154,156 towards one another. To change gear ratio, handle 76 is rotated and all drive units have similar spring bias systems connected to operate in unison. Thus, any drive unit adjusted during the drive mode of its cycle will allow wedges 154,156 to rotate relative to one another, with handle wedge 154 moving and worm gear wedge 156 remaining stationary. During the non-drive mode of the cycle of the drive train unit, spring 152 and wedge 154 force wedge 156 to rotate back into line with wedge 154, thus rotating the worm 78 and changing transmission ratio.

FIG. 10 shows a retarder device 200 which may optionally be employed. Thus, input shaft 12 and output shaft 94 may be provided with sprockets 202, 204 lined by a chain 206 such that at a certain output shaft over-run speed (relative to input shaft speed) output shaft 94 may drive input shaft 12 using unidirectional device 107. This may be useful for braking and/or for powering a generator connected to input shaft 12.

In other embodiments, the idler gear may be absent and the orbiting gear may directly engage and orbit around the internal gear. This would preferably have a 2:1 internal gear to orbiting gear ratio and may have three drive train units only because each of these could drive by pulling and pushing on six separate unidirectional devices. A 3:1 ratio without idler gear is also possible.

If desired, the variances to the substantially constant speed between theta =−30° and +30° can be eliminated using a contoured slot like the one shown in FIG. 6A. Various modifications may be made to the embodiments described without departing from the scope of the invention as defined by the accompanying claims.

The invention claimed is:

1. A continuously variable transmission comprising a rotary input shaft, a rotary output shaft and a drive train unit between the input and output shafts, the drive train unit including adjuster means for continuously varying a ratio of input shaft speed to output shaft speed, and regulator means for regulating the output shaft speed to be substantially constant at a given substantially constant input speed, characterized in that the regulator means includes an orbital wheel being adapted to transmit power from an output element located eccentrically thereon.

2. A transmission as claimed in claim 1, in which the orbital wheel is driven in an orbit around an interior periphery of an internal wheel.

3. A transmission as claimed in claim 2, in which the orbital wheel is further driven by an idler wheel.

4. A transmission as claimed in claim 2, in which the orbital wheel is directly driven by engagement with the interior periphery of the internal wheel.

5. A transmission as claimed in claim 2, in which the orbital wheel has one-third of a radius of the internal wheel.

6. A transmission as claimed in claim 1, in which the output element is located from 0.05R to 0.25R from a center of the orbital wheel, where R is a distance from the center of the orbital wheel to a center of a circular orbiting motion thereof.

7. A transmission as claimed claim 2, in which each said wheel comprises a toothed gear.

8. A transmission as claimed in claim 1, in which the output element is adapted to reciprocate a drive rod via a slot, the regulator means regulating the drive rod to move with a cycle having a portion of substantially constant speed linear motion.

9. A transmission as claimed in claim 8, in which the slot is substantially perpendicular to a direction of reciprocation of the rod.

10. A transmission as claimed in claim 8, in which the regulator means includes a non-linear contour formed in the slot.

11. A continuously variable transmission comprising a rotary input shaft, a rotary output shaft and a drive train unit between the input shaft and output shaft, the drive train unit including adjuster means for continuously varying the ratio of input shaft speed to output shaft speed, characterized in that the adjuster means is passively operable whereby ratio change may be provided without actively driving the output shaft upon an input adjustment to the adjuster means.

12. A transmission as claimed in claim 11, in which the adjuster means includes a lost motion device enabling motion of an input adjuster of the adjuster means to be lost during a driving mode of the drive train unit.

13. A transmission as claimed in claim 12, in which the lost motion device includes a spring bias, the spring bias being arranged to recover lost motion during a non-driving mode of the drive train unit for changing a transmission ratio.

14. A transmission as claimed in claim 8, in which the adjuster means includes an arcuate member having one point thereon driven by the drive rod for selectively pivoting the arcuate member about a pivot point.

15. A transmission as claimed in claim 14, in which the adjuster means includes means for moving a pivot point for varying a ratio of input shaft speed to output speed of the transmission.

16. A transmission as claimed in claim 14, in which an output rod is provided with one point thereon adapted to be selectively driven by the arcuate member.

17. A transmission as claimed in claim 16, in which the output rod is adapted to drive the output shaft via a unidirectional coupling.

18. A transmission as claimed in claim 11, which includes six said drive train units operating at 60° steps out of phase with one another.

19. A transmission as claimed in claim 1, which includes three or more said drive train units operating at equal angular steps out of phase with one another.

20. A transmission as claimed in claim 11, in which the adjuster means is arranged to be operable to a 1:0 input to output shaft speed ratio.

21. A transmission as claimed in claim 1, in which the adjuster means is arranged to be operable to above a 1:1 input to output speed ratio with output speed higher than input speed.

22. A continuously variable transmission comprising a rotary input shaft, a rotary output shaft and a drive train unit between the input shaft and output shaft, a drive train unit including adjuster means for continuously varying the ratio of input shaft speed to output shaft speed, and a regulator means for regulating output shaft speed to be substantially constant at a given substantially constant input shaft speed, characterized in that the regulator means includes an orbital wheel adapted to reciprocate a linearly slidable rod via a slot, the slot having a non-linear contour for regulating the rod to move with a cycle having a portion of substantially constant speed linear motion.

23. A transmission as claimed in claim 22, including a controller for controlling the adjuster means to maintain output shaft speed constant upon variance of input shaft speed.
